(19) United States
(12) Patent Application Publication
(10) Pub. No.: US 2019/0205984 A1
(43) Pub. Date: Jul. 4, 2019

(54) System and Methods for Aggregating and Presenting Securities Trading Data

(71) Applicant: Dough, Inc., Chicago, IL (US)

(72) Inventors: Linwood MA, Chicago, IL (US); Kristi ROSS, Oak Park, IL (US); Tom SOSNOFF, Chicago, IL (US)

(21) Appl. No.: 16/233,677

(22) Filed: Dec. 27, 2018

Related U.S. Application Data
(63) Continuation of application No. 14/710,016, filed on May 12, 2015, now abandoned.
(60) Provisional application No. 61/991,683, filed on May 12, 2014.

(51) Int. Cl. G06Q 40/04

(52) U.S. Cl. CPC G06Q 40/04

(57) ABSTRACT

An improved trading platform may: (i) aggregate multiple orders related to a single trade position and present those orders for the trader; (ii) enable the user to select and apply default options trading strategies; (iii) aggregate trade positions, such as option positions having the same or similar expirations, for presentment in a single interface; and (iv) record and present trade position variations investigated by a trader in a simplified manner.

### CROSS-REFERENCE TO RELATED APPLICATION

This application claims the benefit of priority to U.S. provisional application No. 61/991,683, filed May 12, 2014, which is hereby incorporated by reference in its entirety.

### BACKGROUND

### a. Technical Field

The present disclosure relates generally to a system and methods for aggregating and presenting securities trading data. More particularly, the present disclosure relates to a system and methods for aggregating and presenting data related to options trades to enable a trader to make well-informed, quick trading decisions through a computer-based trading platform.

### b. Background Art

The development of online stock brokerage has led to the proliferation of computer-based brokerage and investment applications. The focus of these applications have typically been to provide sophisticated consumers with more and more complex tools to analyze investment opportunities. These tools may include complex charting, order routing and product discovery. The end result is that the average consumer is left more overwhelmed than assisted by the current investment applications.

Known trading platforms and tools generally do not provide aggregation and display of many types of data that may aid the trader in reviewing and ordering trades. Accordingly, there is a need for a platform with more robust data aggregation and display features.

### BRIEF SUMMARY

An objective of the present disclosure is a trading platform that overcomes the deficiencies of existing platforms and systems by providing improved aggregation and provision of trade data to enable the user to make more informed and quicker trading decisions. In doing so, and among other functionality, the trading platform may for example: (i) aggregate multiple orders related to a single trade position and present those orders to the trader in a easily understandable format; (ii) enable the user to select and utilize option trading strategies or to apply default options trading strategies; (iii) aggregate, group, regroup, and/or arbitrarily organize trade positions, such as option positions having the same or similar expirations, for presentment in a single interface; and (iv) record and present trade position variations investigated by a trader in a simplified manner.

Other objects and advantages of the present disclosure will become apparent to one having ordinary skill in the art after reading the specification in light of the drawing figures, however, the spirit and scope of the present disclosure should not be limited to the description of the embodiments contained herein.

### BRIEF DESCRIPTION OF THE DRAWINGS

FIG. 1 is a block diagram view of an exemplary embodiment of a security trading system.

FIG. 2 is a flow chart illustrating an exemplary embodiment of a method of aggregating trade data and presenting an order chain.

FIG. 3 depicts an exemplary set of order chains in a graphical user interface (GUI) that may be provided consistent with the present disclosure.

FIG. 4 depicts an exemplary trade analysis in a GUI that may be provided consistent with the present disclosure.

FIG. 5 is a flow chart illustrating an exemplary embodiment of a method for setting and applying a set of trading strategy characteristics of a plurality of trades of securities.

FIG. 6 depicts an exemplary presentation of trading strategy profiles.

FIG. 7 depicts an exemplary presentation of trading strategy profiles.

FIG. 8 is a flow chart illustrating an exemplary embodiment of a method for aggregating and providing to a trader plurality of variations of a securities trade order.

### DETAILED DESCRIPTION

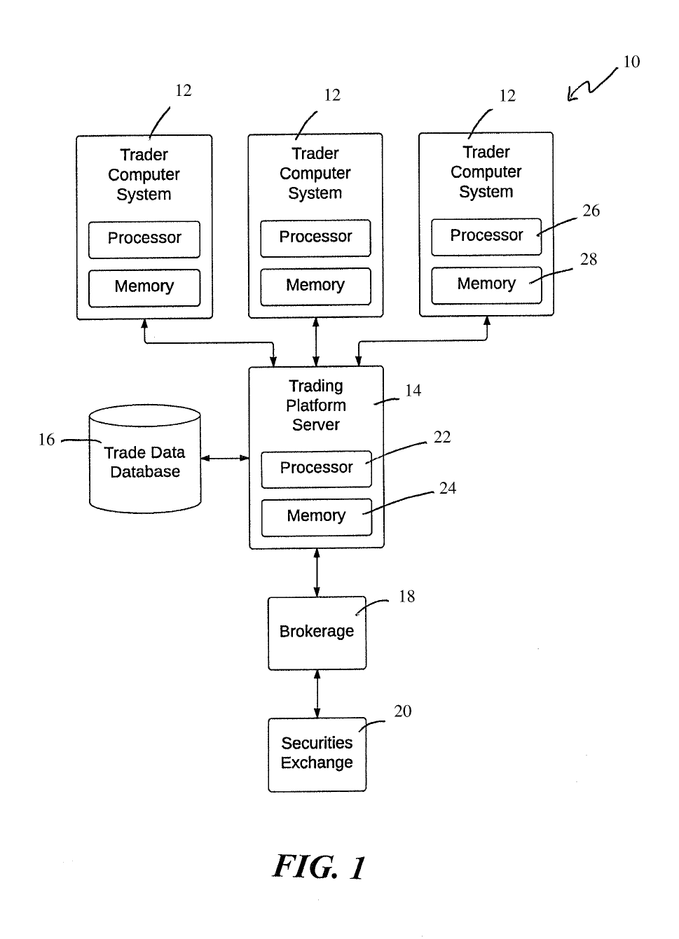

Referring to the drawings, wherein like reference numerals refer to the same or similar features in the various views, FIG. 1 is a block diagram view of an exemplary system for trading securities 10. The system may include a plurality of trader computer systems 12 (three such trader computer systems are illustrated in FIG. 1), a trading platform server 14, a trade history database 16, a brokerage 18, and a securities exchange 20.

The securities exchange 20 may be a marketplace for buying and selling securities (not shown) such as, for example only, stocks, bonds, futures, and options. The exchange 20 may be or may include an electronic marketplace, a live marketplace, or any other type of marketplace for buying and selling securities (not shown). The present disclosure will be described with reference to embodiments in which the traders purchase and sell, and the brokerage 18 facilitates the purchase and sale of, stock options. It should be understood, however, that the present disclosure is not limited to stock options. Rather, the system and methods illustrated and described herein may find use with any type of securities.

The brokerage 18 may facilitate buying and selling of stock options by traders on the exchange 20. Accordingly, the brokerage 18 may be in communication with the traders (i.e., through the trader computer systems 12 and/or the trading platform server 14, in an embodiment) and with the exchange 20. In an embodiment, the brokerage 18 may receive orders for buying and selling stock options electronically from the traders and perform the ordered trades on the exchange 20 or cause the ordered trades to be performed on the exchange 20.

Each of the trader computer systems 12 may be configured to provide access to a trading platform 10. The trading platform 10 may be operated by a trader to, for example, order option trades on the exchange, view stock and options prices and other trading data, access educational and entertainment materials, and view data respective of one or more accounts held by the user with the brokerage 18. The trading platform 10 may include one or more features set forth in U.S. provisional application No. 61/883,676, filed Sep. 27, 2013 (“the '676 application”), which is hereby incorporated by reference in its entirety.

The trading platform server 14 may be configured to perform a number of functions to assist traders in their trading decisions. For example, the trading platform server 14 may be configured to provide stock and options prices, educational and entertainment information, and other information to traders through the trader computer systems 12. Stock and options prices may be obtained by the trading platform server 14, in an embodiment, from the brokerage 18 and/or from the securities exchange 20.

The trading platform server 14 may be further configured to store data in and retrieve data from the trade data database 16. Data stored in the trade data database 16 may include records of trades ordered by traders, records of trades executed by or through the brokerage 18, historical stock and options prices, and similar information related to trading services that may be performed through the trading platform 10.

The database 16 may be or may include one or more data repositories including, but not limited to, one or more databases and database types as well as data storage that may not necessarily be colloquially referred to as a “database.” The database 16 may be configured to store, e.g., records of trades ordered by traders, records of trades executed by or through the brokerage 18, historical stock and options prices, and similar information related to trading services that may be performed through the trading platform 10.

The trading platform server 14 may be in electronic communication with the trader computer systems 12 and with the brokerage 18 to obtain and deliver stock and options prices, trader orders, and other information, in an embodiment. In embodiments, the trading platform server 14 may be owned or operated by the brokerage 18. Furthermore, the trade platform server 14 may be a single server, or multiple servers acting in a redundant or additive capacity.

In embodiments, the trader computer systems 12 may be configured to perform one or more of the functions described herein with reference to the trading platform server 14 and/or the brokerage 18. Accordingly, the trader computer systems 12 may be in direct electronic communication with the brokerage 18, the trade data database 16, and/or the securities exchange 20.

The trading platform server 14 may include a processor 22 and a memory 24. The processor 22 may be any appropriate processing device. The memory 24 may be any volatile or non-volatile computer-readable memory. The memory 24 may be configured to store instructions that embody one or more steps, methods, processes, and functions of the trading platform server 14 described herein. The processor 22 may be configured to execute those instructions to perform one or more of the same steps, methods, processes, and functions.

Each of the trader computer systems 12 may also include a processor 26 and a memory 28, with three processors and three memories illustrated in FIG. 1. Each processor 26 may be any appropriate processing device. Each memory 28 may be any non-transitory, volatile or non-volatile computer-readable memory and may be configured to store instructions that embody one or more steps, methods, processes, and functions of the trader or trader computer system 12 described herein. The processor 26 may be configured to execute those instructions to perform one or more of the same steps, methods, processes, and functions. One or more of the trader computer systems 12 may be or may include a personal computer or mobile device (e.g., tablet, smartphone), in an embodiment.

Instead of, or in addition to, a processor 22, 26 and memory 24, 28, the trading platform server 14 and/or one or more of the trader computer systems 12 may include a programmable logic device (PLD), application-specific integrated circuit (ASIC), or other suitable processing device (not shown).

As noted above, a trader in the system may be provided with a platform 10 for, among other things, ordering the purchase and sale of stock options, reviewing trading data, and accessing educational and entertainment information. The platform 10 may be provided, in an embodiment, by both the trader computer system 12 and the trading platform server 14. That is, some elements or features of the platform 10 may be installed on the trader computer system 12, and other elements or features of the platform 10 may be provided by the trading platform server 14 (e.g., on a software-as-a-service (SaaS) basis). For example, the trader computer system 12 may provide (i.e., may have installed) a program that includes a graphical user interface of the platform 10, and the trading platform server 14 may provide much of the underlying data and calculations. However, storage and retrieval of data displayed in the platform 10, calculations performed by or under the platform 10, and services provided through the platform 10 may be performed by one or both of the trader computer system 12 and the trading platform server 14.

The platform 10 may include a number of features that enhance the trading experience for a trader. For example, the platform 10 may be configured to: aggregate multiple orders related to a single trade position and present those orders for the trader; enable the user to select and apply default options trading strategies; aggregate trade positions, such as option positions having the same or similar expirations, for presentment in a single interface; and record and present trade position variations investigated by a trader in a simplified manner. As described above, these functions may be performed by one or both of the trading platform server 14 and the trader computer system 12. For ease of discussion, these functions are described below with reference to methods comprising steps performed primarily by the trading platform server 14. It should be understood, however, that the methods described below are not restricted to performance by the trading platform server 14.

Aggregating and Presenting Order Chains. One common behavior in options trading is the adjustment of positions one or more times prior to the complete exit of a position. This behavior, known as rolling, is designed to adjust a position to take more or less risk, or give a user more time in order for time to work to their advantage in a trade. As such, one common issue is the tracking of the trading history, as many of these positions are not simple open (buy) then close (sell). As such, there is a need for a tool to crawl, understand, and group order history's into easy to follow order chains to make reviewing of order history more understandable for the trader. Order chains do just that, simply and visually display complex order history in a simple to follow format, grouping related positions into an understandable (e.g., chronological) presentation.

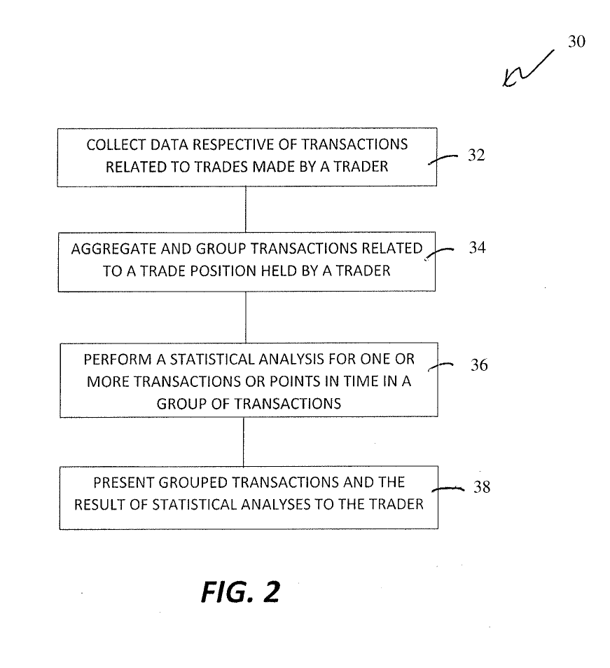

A method of aggregating trade data and presenting an order chain 30 may be performed by the trading platform server 14, in an embodiment. FIG. 2 is a flow chart illustrating an embodiment of such a method 30.

Referring to FIG. 2, the method 30 may begin with a step 32 that includes collecting data respective of transactions related to trades made by a trader. Data may include or relate to, for example and without limitation, the trader's own trade history, transactions by or related to one or more stock-issuing entities, and market data including movement of records of stock and option prices. Referring to FIGS. 1 and 2, data may be collected from numerous sources, in an embodiment, including the trade data database 16, the brokerage 18, and the security exchange 20, among others.

Data may also be collected from a user computer system (not shown), in an embodiment. For example, a trader may manually organize, decompose, recompose and augment the data with additional information.

With continued reference to FIG. 2, the method may further include a step 34 that includes aggregating and grouping transactions related to a trade position held by a trader. In an embodiment, data related to a plurality of different trade positions may be aggregated and separated in a plurality of different groups. For example, data may be grouped according to a reference starting date (i.e., the date on which the trader first took the trade position of interest, referred to herein as “the snapshot date”) and the first opening trade, which includes a yet unrelated symbol. Thus a number of different positions may be associated with different symbols.

For each symbol, the first opening order in that underlying position may be identified. From there, each overlapping order where an exercise, assignment, corporate action, transfer, or buy or sell is found that relates to the order, and is grouped until all positions related to that initial opening order are closed, or the order has reached a closing state. This process may be repeated for the next oldest opening order until all orders in a given underlying position, and all underlying positions have been accounted for. This grouping results in “order chains.”

The resulting grouped data set (i.e., an order chain) may include opened and closed orders, expirations, assignments, and corporate actions that occurred during the time period from the snapshot date until the present day (or a different selected end date), along with any resulting open trade position.

The method may continue with a step 36 that includes performing a statistical analysis for one or more transactions or points in time in a group of transactions (e.g., in an order chain). For example, once orders are organized into chains, realized and unrealized gain associated with one or more points in time or one or more transactions in a group, may be calculated. In an embodiment, realized and unrealized gain at each transaction in a full cycle of trades within an order chain may be calculated. Additionally or alternatively, the implied volatility at one or more points in time or at one or more transactions within a group may be calculated. Additionally or alternatively, information including trade type and various other entry and exit characteristics may be associated with one or more transactions. Further examples of statistical analyses that may be performed are discussed in the '676 application, referenced above.

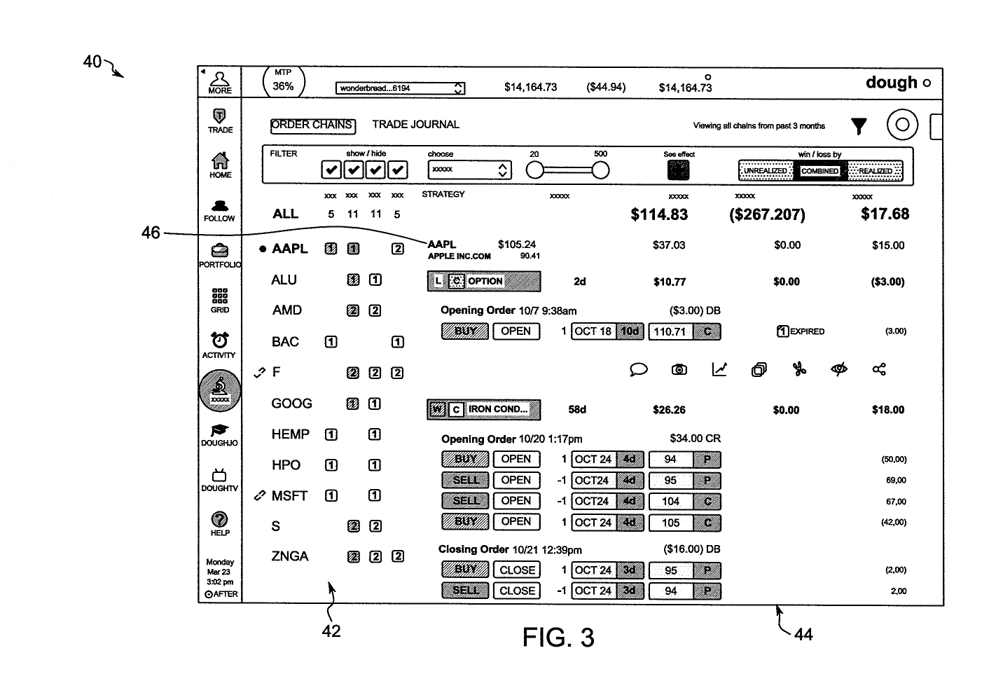

The method may continue with a step 38 that includes presenting grouped transactions and the result of statistical analyses to the trader. In an embodiment, the grouped transactions and the result of statistical analyses may be provided to the trader for presentation on a display associated with the trader's computer system 12 (see FIG. 1). An exemplary embodiment of presented order chains 40 is shown in FIG. 3. As shown, in an embodiment, a plurality of order chains 42 may be shown for a single trader. Each order chain 42 may include trades 44 made with respect to a single stock 46. Trades 44 within an order may be displayed together, and orders within a chain 42 may be ordered in a logical or meaningful way, such as chronologically, in an embodiment.

In addition, a trader may be presented with recommendations based on profitable characteristics of trades 44 in an order chain 42 at order entry and order exit. For example, the analysis may result in a conclusion that a given trader typically has more profitable trades when they reach 80% of max profit, or do better trading AAPL or GOOG. Such conclusions may be presented to the trader to highlight for when the trader's profitable trading occurs.

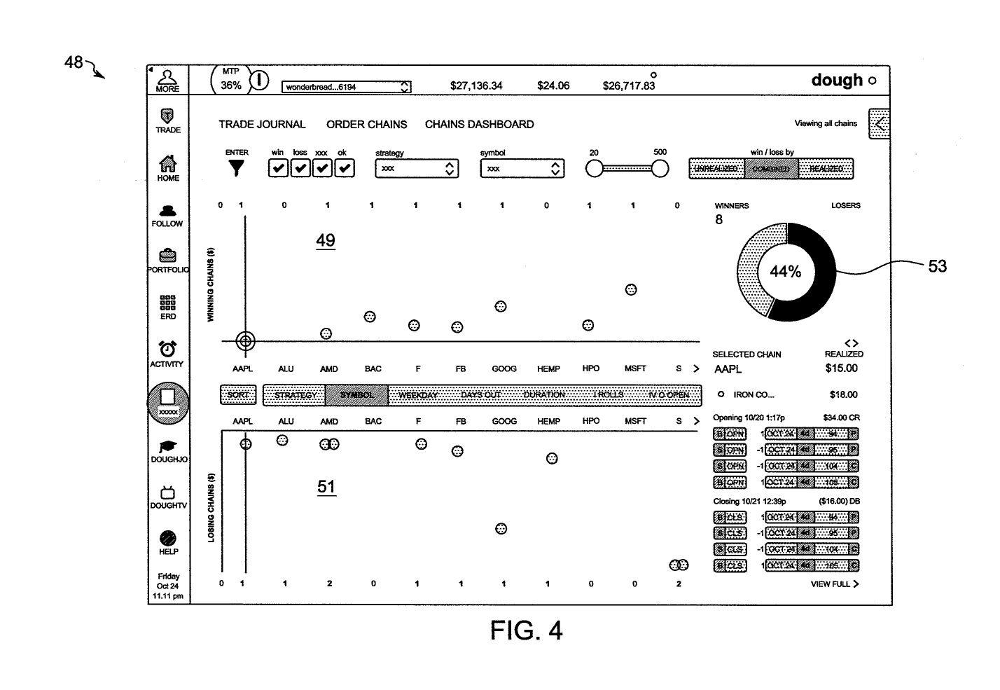

Analysis of transactions may also be presented to the trader, as noted above, which may enable traders to see their profitable and unprofitable decisions and filter and scan through a variety of charts and graphs to understand their trading areas of strengths and weakness by underlying order strategy and order conditions. FIG. 4 illustrates an exemplary embodiment of a trader analysis page 48. The trader analysis 48 may include, for example, a summary or listing of profitable order chains 49, a summary or listing of non-profitable order chains 51, and an overall success rate 53. The profitable order chains 49 and non-profitable order chains 51 may be sortable and selectable according to a strategy type, a stock symbol, a time period or time of trade (e.g., weekday), or other characteristic of the trade, in an embodiment. The success rate may be illustrated in a graph, expressed as a percentage or ratio, or presented in some other appropriate form.

Setting and Applying Trading Strategy Profiles. In trading, one of the most time consuming tasks in setting a trade order is adjusting different aspects of the trade to a trader's preferences. For example, some traders prefer short term trades with lower likelihoods of success for an individual trade, while other traders prefer to trade over longer periods of time, with a higher likelihood of success for an individual trade. Each time a trade is made, the trader must select an expiration, strike price, and/or strike width, and may need to select a target probability of success to set the other aspects of the trade. Making such selections for each trade individually can be, as noted above, very time consuming.

Referring to FIG. 1, in order to more rapidly allow traders to place orders, the trading platform server 14 may implement a method for setting and applying trade strategy characteristics 50. As part of the method 50, a trader can set the characteristics of their trades, save those characteristics, and have those characteristics remembered so that the next time a trade is placed, the strategy will be placed as they typically prefer, both at the expirations they prefer, strikes and width they prefer, or at a target probability of success they prefer.

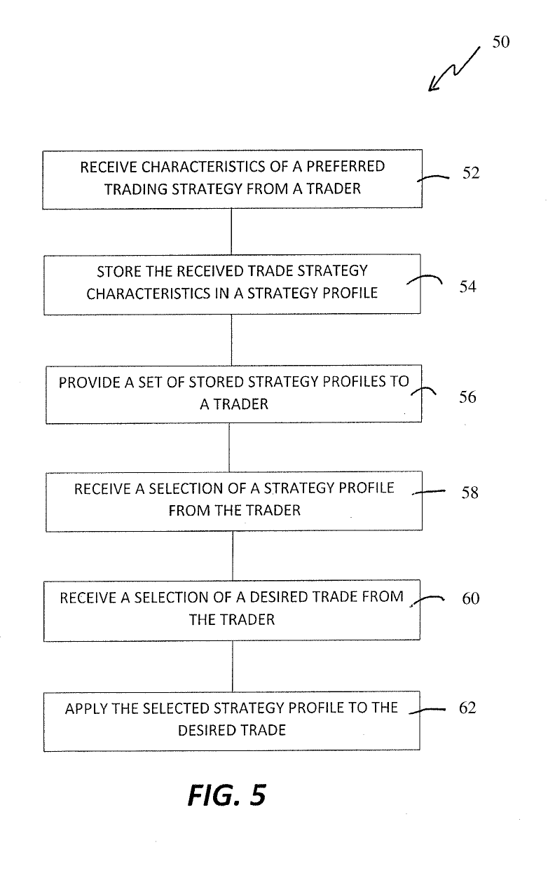

FIG. 5 is a flow chart illustrating an exemplary embodiment of a method for setting and applying trade strategy characteristics 50. The method may begin with a step 52 that includes receiving characteristics of a preferred trading strategy from a trader. The characteristics may include, for example and without limitation, a preferred strike width, a preferred expiration range (e.g., a preferred amount of time between when an option trade is ordered and the expiration of the option), a desired projected probability of success, etc.

The method may further include a step 54 that includes storing the received trade strategy characteristics in a strategy profile. A single trader may have multiple strategy profiles, in an embodiment. Thus, the receiving characteristics step and the storing characteristics step may be performed numerous times for a single trader, in an embodiment.

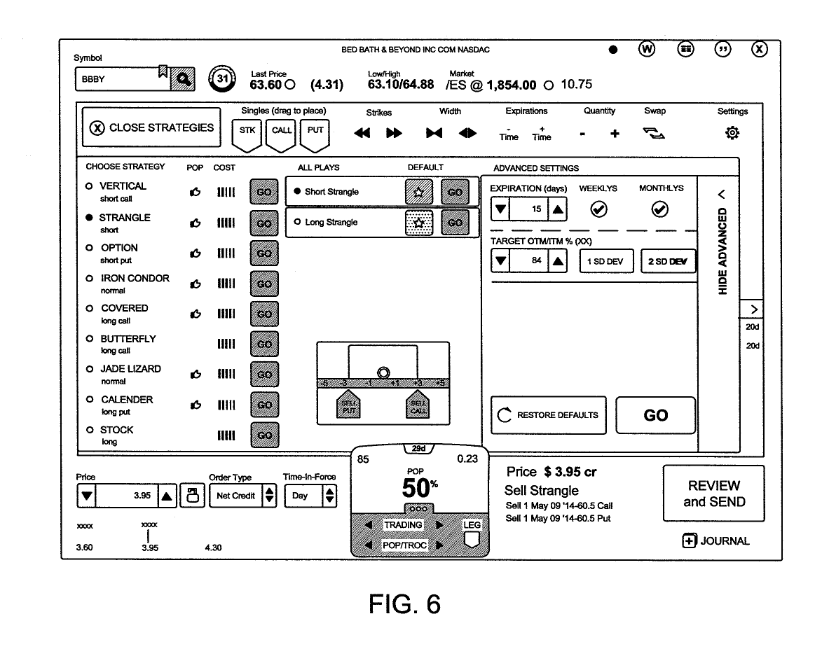

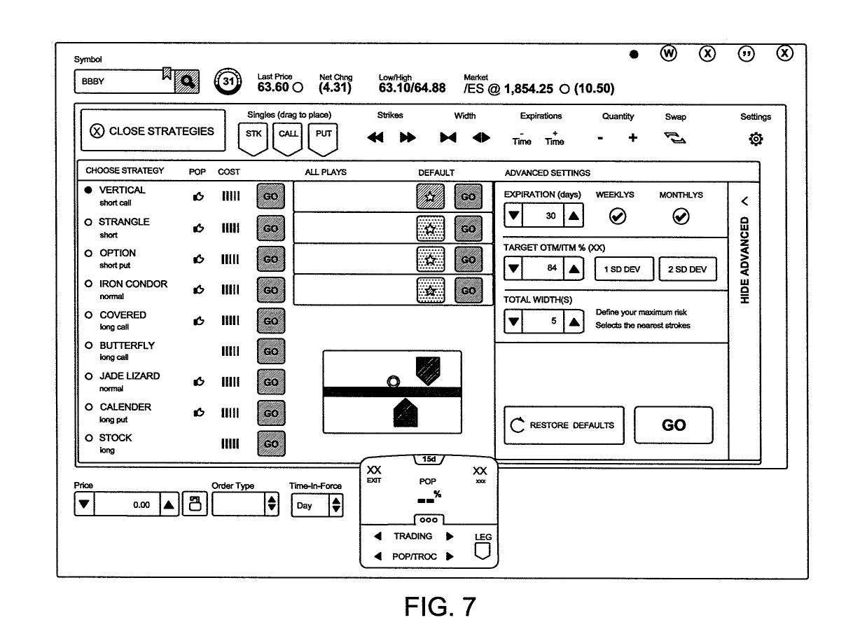

The method may further include the step 56 of providing a set of stored strategy profiles to a trader. The set of stored strategy profiles may include one of more stored strategy profiles associated With the trader (i.e., associated with the trader via the receiving characteristics step and the storing characteristics step), in an embodiment. The set of stored strategy profiles may additionally or alternatively include strategy profiles associated with individuals other than the trader, in an embodiment. For example, the set of stored strategy profiles may include strategy profiles selected by or associated with expert traders, celebrities, or featured traders. Such strategy profiles may be used by a common trader just as a common cook might use a cookbook published by an expert or celebrity chef. An exemplary presentation of strategy profiles is illustrated in FIGS. 6 and 7.

Referring again to FIG. 5, the method may further include the step 58 of receiving a selection of a strategy profile from the trader. As noted above, the strategy profile may include one or more of a strike width, expiration range, a desired probability of success, and/or other characteristics of an option trade or other securities trade.

The method may further include the step 60 of receiving a selection of a desired trade from the trader. For example, the trader may provide a selection of a put option for a given stock, a call option for a given stock, or some other desired options trade or other securities trade.

The method may further include the step 62 of applying the selected strategy profile to the desired trade. The characteristics of the strategy profile may be compared to the characteristics of available trades, and the closest available trade or trades may be presented to the trader. For example, in an embodiment, the available trades may be narrowed according to expirations that match or are close to the expiration range of the strategy profile. After an expiration is identified, a specific stock price that would represent a likelihood of success that is similar or equal to the strategy's target projected probability of success (e.g., in the money or out of the money). From there, the closest option strike in the selected expiration may be identified, and, if there is a width preference, the closest option to the target width is identified and placed.

Quick Close-Aggregating and Presenting a Plurality of Trade Positions. Traders may place multiple orders at a time and, depending upon their trading style, many options held by a trader may expire at the same time. For example, a number of options held by the same trader may expire on a given day of a month when options generally expire. Thus, although order entry on opening orders may happen at sporadic times, closing of orders may occur simultaneously, with a user having to manage and adjust pricing and closing conditions on multiple orders at the same time. The ability to easily view and manage multiple positions at the same time can be beneficial, particularly as the expiration of numerous options approaches.

Referring back to FIG. 1, the trading platform 10 (e.g., through the configuration of the trading platform server 14 and/or a trader computer system 12) may be configured to aggregate and display a plurality of trading positions. In particular, the platform 10 may be configured to aggregate and display a plurality of option positions that are the same or similar with respect to one or more characteristics of the option positions such as, but not limited to, the same or similar expirations. Such an aggregated display may allow the trader to quickly close multiple positions within a short period of time. Hence, the aggregated display will be referred to herein as the quick close mechanism (i.e., the platform 10 may be configured to provide the quick close mechanism).

The quick close mechanism may include a display of a plurality of working orders at the same time in an easy to read table, grid, or other integrated format. As a result, instead of being forced to navigate to a separate portion of the platform 10 (e.g., a different web page) every time a user wants to adjust an order, a trader may be able to view and adjust (e.g., close) multiple positions in a single interface of the platform 10. In an embodiment, for each order displayed, the trader's current price and the current trading price of the order are displayed to, among other things, give the trader a sense of how close each order is to being executed so that the trader can make informed decisions about whether to adjust multiple orders within a short period of time.

Aggregating and Displaying Numerous Variations of an Order. Often times when creating orders, especially in options orders, due to the sheer volume of variations that exist (different strikes, expiration, option types, and the ability to buy or sell), traders often will cycle through and compare multiple variations of orders prior to executing a trade. During this process, a trader may wish to return to a previously-viewed variation. In known trading systems, a trader is generally left without an easy way to adjust an order back to a previous variation of that order, without re-creating the order in the system.

Referring again to FIG. 1, the trading platform server 14 may be configured to execute a method for aggregating and providing to a trader numerous variations of an order. The method may enable the trader to easily return to previously-viewed order variations to quickly and easily compare different variations of an order and select one having desired characteristics.

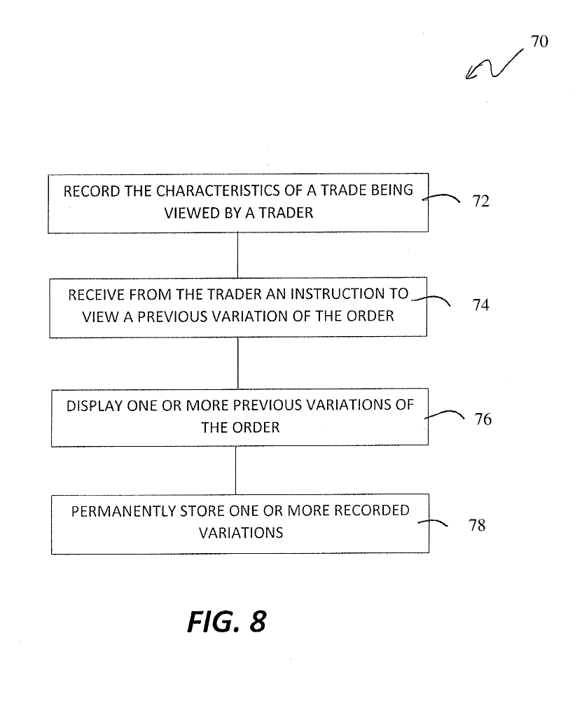

FIG. 8 is a flow chart illustrating an exemplary embodiment of a method for aggregating and providing to a trader plurality of variations of a securities trade order 70. The method may operate, in an embodiment, while a trader is viewing characteristics of an order through, for example, an order placement interface of a trading platform 10.

The method 70 may begin with a step 72 of recording the characteristics of a trade being viewed by a trader. For example, a strike price, strike width, expiration, and other characteristics of an option position may be recorded. The recording may be automatic, in an embodiment. For example, the platform 10 may automatically take a “snapshot” of a trade being viewed by the trader. Additionally or alternatively, the recording may be initiated by the trader (e.g., through a “Save Trade” or similar mechanism in the platform 10). Recorded trade characteristics may be stored in a trade data database, a trader's computer system, or a trading platform server 14, in an embodiment (see FIG. 1).

In an embodiment, trade characteristics may be automatically recorded on a periodic basis. For example, but without limitation, a “snapshot” of the trader's order interface may be taken every five hundred milliseconds (500 ms). Of course, other time periods are possible and contemplated. Each snapshot may be stored, in an embodiment. Alternatively, snapshots that are the same as a previous snapshot (i.e., if the trader has not adjusted trade characteristics through the interface since the previous snapshot) may be discarded, in an embodiment.

The method may further include a step 74 that includes receiving from the trader an instruction to view a previous variation of the order and a further step 76 that includes displaying one or more previous variations of the order. The instruction may be received, for example only, through a dedicated button in the trading platform interface. Such a dedicated button may function in a manner similar to a “Back” button on a web browser, in an embodiment, sequentially going back through recorded variations with each click of the button. Similarly, a dedicated button may also be provided that functions similarly to a “Forward” button in a web browser, in an embodiment, sequentially going forward through recorded variations with each click of the button. Additionally or alternatively, the trader may be provided with a table, list, or other view of numerous variations of the trade.

The method may further include a step 78 that includes permanently storing one or more recorded variations. For example, variations may be stored according to stock symbol (i.e., such that the history of variations for the Symbol AAPL is distinct from the symbol FB) or some other characteristic of the trade. When switching symbols or other characteristics within the trading platform 10, if an existing history or recorded variations is already available for a symbol or other characteristics, the interface may display one or more of the variations and may provide immediate access to the variations to allow the user to provide an instruction to view a previous variation of the trade.

Various embodiments are described herein to various apparatuses, systems, and/or methods. Numerous specific details are set forth to provide a thorough understanding of the overall structure, function, manufacture, and use of the embodiments as described in the specification and illustrated in the accompanying drawings. It will be understood by those skilled in the art, however, that the embodiments may be practiced without such specific details. In other instances, well-known operations, components, and elements have not been described in detail so as not to obscure the embodiments described in the specification. Those of ordinary skill in the art will understand that the embodiments described and illustrated herein are non-limiting examples, and thus it can be appreciated that the specific structural and functional details disclosed herein may be representative and do not necessarily limit the scope of the embodiments, the scope of which is defined solely by the appended claims.

Reference throughout the specification to “various embodiments,” “some embodiments,” “one embodiment,” or “an embodiment”, or the like, means that a particular feature, structure, or characteristic described in connection with the embodiment is included in at least one embodiment. Thus, appearances of the phrases “in various embodiments,” “in some embodiments,” “in one embodiment,” or “in an embodiment”, or the like, in places throughout the specification are not necessarily all referring to the same embodiment. Furthermore, the particular features, structures, or characteristics may be combined in any suitable manner in one or more embodiments. Thus, the particular features, structures, or characteristics illustrated or described in connection with one embodiment may be combined, in whole or in part, with the features structures, or characteristics of one or more other embodiments without limitation given that such combination is not illogical or non-functional.

Although numerous embodiments of this invention have been described above with a certain degree of particularity, those skilled in the art could make numerous alterations to the disclosed embodiments without departing from the spirit or scope of this disclosure. All directional references (e.g., plus, minus, upper, lower, upward, downward, left, right, leftward, rightward, top, bottom, above, below, vertical, horizontal, clockwise, and counterclockwise) are only used for identification purposes to aid the reader's understanding of the present disclosure, and do not create limitations, particularly as to the position, orientation, or use of the any aspect of the disclosure. As used herein, the phrased “configured to,” “configured for,” and similar phrases indicate that the subject device, apparatus, or system is designed and/or constructed (e.g., through appropriate hardware, software, and/or components) to fulfill one or more specific object purposes, not that the subject device, apparatus, or system is merely capable of performing the object purpose. Joinder references (e.g., attached, coupled, connected, and the like) are to be construed broadly and may include intermediate members between a connection of elements and relative movement between elements. As such, joinder references do not necessarily infer that two elements are directly connected and in fixed relation to each other. It is intended that all matter contained in the above description or shown in the accompanying drawings shall be interpreted as illustrative only and not limiting. Changes in detail or structure may be made without departing from the spirit of the invention as defined in the appended claims.

Any patent, publication, or other disclosure material, in whole or in part, that is said to be incorporated by reference herein is incorporated herein only to the extent that the incorporated materials does not conflict with existing definitions, statements, or other disclosure material set forth in this disclosure. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material.

What is claimed is:

1. A non-transitory, computer-readable memory storing instructions that, when executed by a processor, cause the processor to perform a method for aggregating and presenting securities trading data, the method comprising:
a) collecting data respective of transactions related to trades made by a trader;
b) aggregating and grouping transactions related to a trade position held by a trader;
c) performing a statistical analysis for one or more transactions or points in time in a group of transactions; and
d) presenting the grouped transactions and the result of the statistical analysis to the trader in a graphical user interface.

2. The non-transitory, computer-readable memory of claim 1, wherein the trade position is with respect to a single stock symbol.

3. The non-transitory, computer-readable memory of claim 1, wherein the statistical analysis comprises a realized and unrealized gain.

4. The non-transitory, computer-readable memory of claim 1, wherein the statistical analysis comprises an implied volatility.

5. The non-transitory, computer-readable medium of claim 1, wherein the transactions comprise at least opened and closed orders by the trader, expirations, assignments, and corporate actions.

6. A non-transitory, computer-readable memory storing instructions that, when executed by a processor, cause the processor to perform a method for aggregating and presenting securities trading data, the method comprising:
a) receiving characteristics of a preferred trading strategy from a trader;
b) storing the received trade strategy characteristics in a strategy profile;
c) providing a set of stored strategy profiles to the trader;
d) receiving a selection of a strategy profile from the trader;
e) receiving a selection of a desired trade from the trader; and
f) applying the selected strategy profile to the desired trade.

7. The non-transitory, computer-readable medium of claim 6, wherein the set of stored strategy profiles comprises the preferred trading strategy and one or more trading strategies not defined by the trader.

8. The non-transitory, computer-readable medium of claim 6, wherein the set of stored strategy profiles comprises the preferred trading strategy and a plurality of additional trading strategies defined by the trader.

9. The non-transitory, computer-readable medium of claim 6, wherein (f) comprises:
comparing characteristics of the selected strategy profile to the characteristics of available trades for the desired trade;
finding one or more available trades that are closest to the selected strategy profile;
presenting the one or more closest available trades to the trader; and
receiving a selection of one of the one or more closest available trades from the trader.

10. The non-transitory, computer-readable medium of claim 6, wherein the characteristics comprise one or more of a strike width, expiration range, or a desired probability of success.

11. A non-transitory, computer-readable memory storing instructions that, when executed by a processor, cause the processor to perform a method for aggregating and presenting securities trading data, the method comprising:
a) recording the characteristics of a trade being viewed by a trader;
b) receiving from the trader an instruction to view a previous variation of the order;
c) displaying one or more previous variations of the order; and
d) permanently storing one or more recorded variations.

12. The non-transitory, computer-readable medium of claim 11, wherein the characteristics comprise a strike price, strike width, and an expiration.

13. The non-transitory, computer-readable medium of claim 11, wherein (b) comprises providing an input mechanism operable only to receive an instruction to view a previous variation of an order in a graphical user interface used by the trader.

14. The non-transitory, computer-readable medium of claim 11, wherein (a) comprises automatically recording the characteristics of the trade on a repeating periodic basis.

15. The non-transitory, computer-readable medium of claim 11, wherein (a) is preformed responsive to an explicit instruction from the trader.
